(19) United States
(12) Patent Application Publication
(10) Pub. No.: US 2004/0083869 A1
(43) Pub. Date: May 6, 2004

(54) Guide

(76) Inventors: Edmund J. Aziz, Keizer, OR (US); John E. Aziz, Wrightwood, CA (US)

Correspondence Address: Carl D. Crowell, P.O. Box 923, Salem, OR, 97308, US

(21) Appl. No.: 10/286,232

(22) Filed: Oct. 30, 2002

(51) Int. Cl. B26D 7/00; B26D 7/27; B26D 7/28

(52) U.S. Cl. 83/520; 83/522.15

(57) ABSTRACT

A method and apparatus for providing a guide for use with rotary components such as a rotary saw. In the preferred embodiment the invention is comprised of a rotary saw with a blade, a reflector affixed adjacent and coaxial to said blade, a light beam source, preferably a laser projecting a beam of light co-planer to and at said reflector. The reflector acts as a curved mirror to fan the beam of light creating a guideline coplanar with the rotary component or blade of the rotary saw.

### BACKGROUND OF THE INVENTION

1. Field of the Invention

The present invention relates to a guide or method and apparatus for visibly displaying a line for determining the alignment and position of a rotating component. More specifically for displaying a guideline on a work piece along which a cut is to be made in the operation of a rotary saw. In the preferred embodiment, the invention consist of a light beam produced by a laser or like device wherein the light beam is projected onto a reflector coaxially mounted adjacent to a saw blade. The reflector provides a point of divergence for the light beam, creating a guideline indicating the plane of the saw blade.

2. Prior Art

Rotary saws such as circular saws, chop saws, radial arm saws, miter saws and table saws require that the operator properly align the material being cut with the blade. To this end, there exists light and laser-based cut alignment devices which are mounted in the vicinity of the saw and project a light beam along the cut line.

U.S. Pat. No. 5,461,790 to Olstowski discloses a laser device for mounting on the shield of a circular saw to provide a guideline.

U.S. Pat. No. 5,675,899 to Webb discloses a rotary saw with a housing equipped with a laser to provide a guideline.

U.S. Pat. Nos. 5,862,727 to Kelly and U.S. Pat. No. 6,035,757 to Caluori et al, provide for centrifically activated lasers contained within an arbor or blade lock washer mounted co-axially and adjacent to a saw blade.

U.S. Pat. No. 5,996,460 to Waite proves for a light source mounted behind a blade such that a guideline is formed by the blade shadow.

The above devices that act to place a line of light onto a work piece as an alignment marker for guidance of a saw blade have either been designed as an integral part of the rotary saw structure with which those devices function or as a component attached to the cutting unit.

Many of the prior art devices are mounted externally to the blade and require alignment and calibration to ensure that the guideline produced accurately reflects the cut line of the blade. These devices are either integral to the saw in use, or are cumbersome in adapting to existing saws through retrofit.

Select prior art devices (Kelly and Caluori) are integrated with and coaxial to the blade so that no alignment is necessary. These devices may be readily adapted to existing saws, however they require a large number of components to be placed in a volume limited element affixed to a rapidly spinning saw blade which is subjected to significant stresses in normal operation. This leads to high rates of component wear and failure, increased costs due to specialized manufacture, and limited battery life due to the limited device size.

Select prior art devices also require that the saw be in operation for alignment. This is an undesirable condition due to the obvious dangers of having a rotating blade near any work piece that is to be aligned for cutting.

Accordingly there exist a need for a device to provide a readily aligned guideline for use with a rotary saw with improved safety characteristics and without the limitations of device component size and factors associated with component stress and wear found in the prior art.

### SUMMARY OF THE INVENTION

Briefly, there is provided in accordance with the present invention a new and improved method and apparatus to visibly display a guideline on a work piece along which a cut is to be made in the operation of a rotary saw. The invention comprises a light beam source, preferably a laser emitting light beam source mounted such that the beam of light produced by the light beam source is coplanar to and directed at a reflector, which may be a mirrored or chromed washer attached coaxially to the rotary saw blade. The reflector provides divergence of the light beam in a plane parallel to the blade plane. The divergent light forms a guideline representing the blade cut line to permit proper alignment of the saw blade for an intended cut.

Accordingly several objects and advantages of the present invention include:

(a) to provide a method and apparatus to visibly display a guideline on a work piece along which a cut is to be made that is convenient and economical to use;

(b) to provide a method and apparatus to visibly display a guideline on a work piece along which a cut is to be made that can be easily retrofitted to existing rotary saws;

(c) to provide a method and apparatus to visibly display a guideline on a work piece along which a cut is to be made that is self aligning;

(d) to provide a method and apparatus to determine the alignment of a rotary component independent of component operation.

### BRIEF DESCRIPTION OF THE DRAWINGS

A better understanding of the present invention will be had upon reference to the following detailed description, when read in conjunction with the accompanying drawings, wherein like reference characters refer to like parts throughout the several views, in which:

FIG. 1 is a perspective view of a rotary saw incorporating the invention.

FIG. 2 is a perspective view of an alternate embodiment of a rotary saw incorporating the invention.

FIG. 3 illustrates a light beam directed at a point of divergence on a reflector creating a line on a surface.

FIG. 4 illustrates an alternate configuration of the invention.

### DETAILED DESCRIPTION OF INVENTION

In the preferred embodiment, a reflector 18 is attached coaxially with a blade 12 for a rotary saw 10. In a conventional saw, a blade bolt is used to hold a blade, washer, arbor and/or lock washer combination and the blade and washer combination are retained by a blade nut. The reflector 18 may be used in place of a lock washer or arbor and held in place in a conventional way. As the reflector 18 occupies the space of existing components on most saws, that of a washer, the invention is readily adapted to existing products. The reflector 18 may be chromed washer, a polished alloy or any suitable material finished with a reflective surface. Though the preferred embodiment utilizes a round mirrored or chromed washer, any reflective surface, faceted or mirrored, proximate and coaxial to the blade 12 may be used.

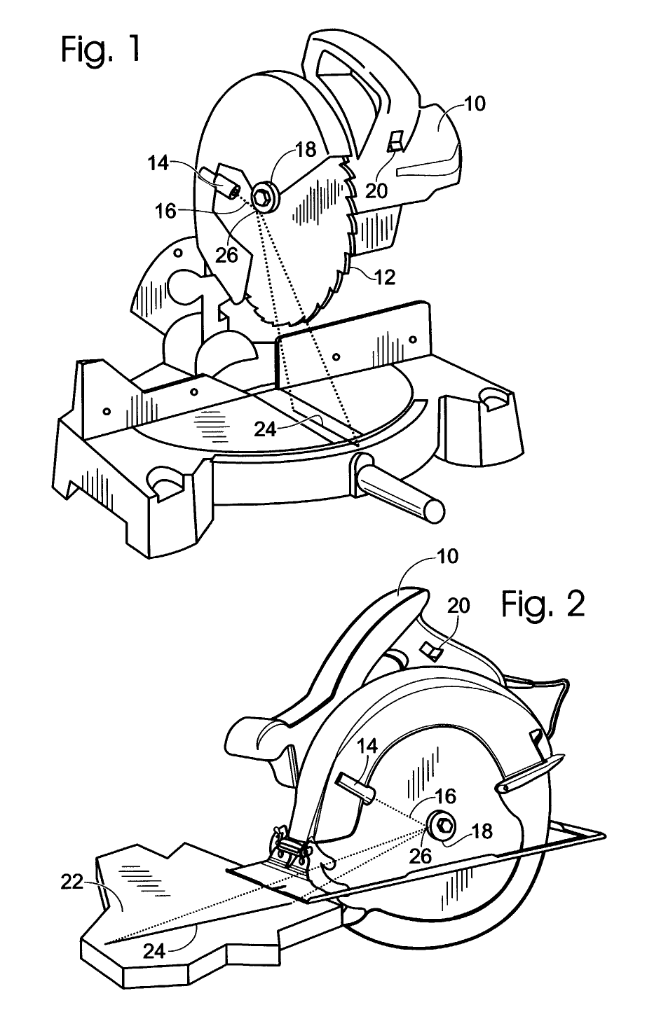

A light beam source 14, preferably a laser, is provided for emitting a beam of light 16. The light beam source 14 is located such that there exists a direct line to the reflector 18 mounted adjacent and coaxial to the blade 12 of the rotary saw 10. The light beam source 14 may be mounted on a portion of the saw 10, such as the blade shield of a conventional circular saw as depicted in FIG. 2. The light beam source 14 may be affixed to the saw 10 as an after market modification, or it may be integral to the saw as depicted in FIGS. 1 and 2. The beam of light 16 is preferably co-planer with the reflector 18 and directed to impact the forward portion of the reflector, which acts as a beam spreading divergent lens.

The reflector 18 provides a point of divergence 26 for the beam of light 16 such that the beam of light 16 is spread to a guideline 24 and projected onto the work piece 22, indicating a coplanar cut line for the blade 12.

The light beam source is operatively connected to a switch 20 and may be powered internally or by the same power source of the rotary saw 10. The switch in use may be in conjunction with a motion sensor type switch to activate the light source 14 on movement of the saw 10.

Operation

The light beam source 14 is affixed to a saw 10 such that it is capable of directing a beam of light 16 to a point of divergence 26 on the reflector 18. A specific point of divergence 26 on the reflector 18 need not be used and adjustments in the angle of the light beam source 14 and point of divergence 26 effect varying lengths and locations of the projected guideline 24.

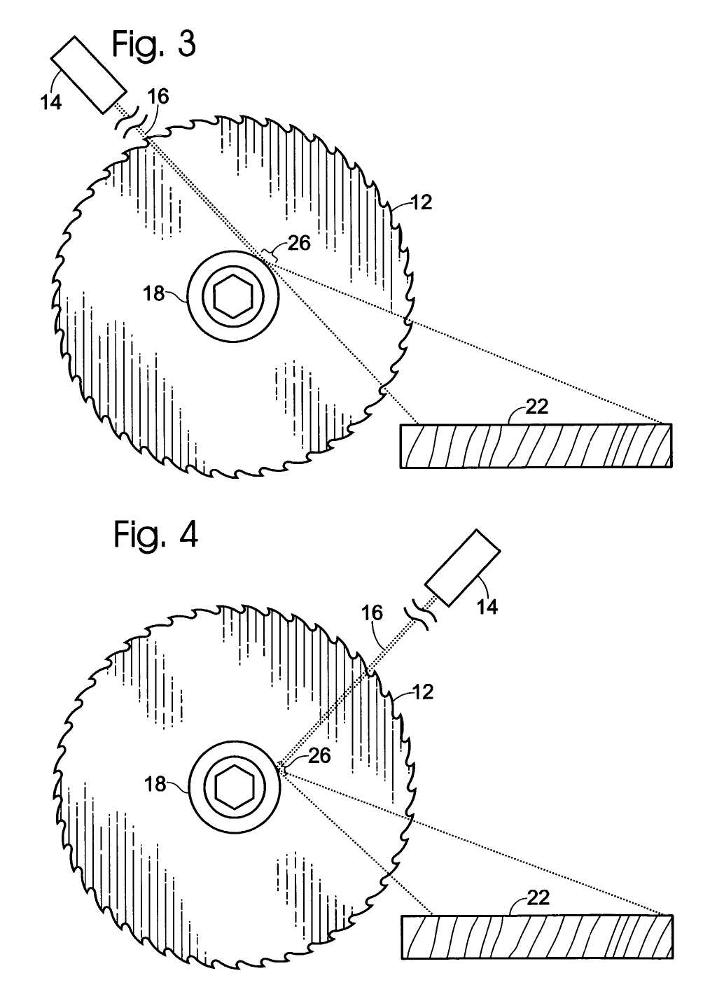

In the preferred embodiment, the light beam source 14 is above and forward the reflector 18 creating an acute reflection as depicted in FIGS. 2 and 4. Other embodiments include the placement of the light beam source 14 in a generally linear position with the reflector 18 and the work piece 22 for an obtuse reflection as depicted in FIG. 3. In FIG. 3, the point of divergence 26 is such that the beam of light 16 is only partially intercepted by the reflector 18. With a partial interception, only a portion of the beam of light 16 is diverted by the reflector 18 providing both a direct point of light on the work piece 22 and a divergent guideline 24.

Alignment of the blade 12 or rotating component is determined by monitoring the reflected beam of light 16. The beam of light 16 when reflected off of the curved surface of the reflector 18 produces a guideline 24 that is readily visible on any work piece 22 to be cut. The guideline 24 may also be monitored to ensure that the blade 12 or rotating component remains in the desired alignment throughout operation. The guideline 24 produced may be of any useful length. The length of the guideline makes any misalignment of the blade 12 or rotating component readily visible.

The light beam source 14 may be activated prior to, in conjunction with, or after turning on the rotary saw 10. When light beam source 14 is activated, an operator may align the work piece 22 to be cut according to the visible guideline 24 which is visible independent of blade rotation. Any number of switches 20 may be incorporated to activate the light beam source 14, including basic toggle switches, switching mechanisms incorporated with the primary saw switch and motion sensing switches that activate the light beam source 14 with any movement of the rotary saw 10.

Though the above disclosed and preferred embodiment relates to the use of providing a guideline 24 for a rotary saw 10, it is also disclosed that the invention may be used to provide a guide for alignment of other devices composed of one or more rotary components such as pulley, belt or gear systems where in it is desirable to be able to regularly monitor alignment of rotary components independent of operation. The reflector 18 may be mounted proximate any rotating component 12. The beam of light 16 reflected off of the reflector 18 produces a line 24 indicating the plane of rotation of the rotating component. This line 24 may be easily monitored by simple visual inspection at some distance to permit safe monitoring.

To those skilled in the art, other variations of the invention will be apparent, including changes and modifications. Such changes and modifications may be carried out without departing from the spirit and scope of the invention, which is intended to be limited only by the claims below.

We claim:

1. A rotary saw and guide for displaying a visible line on a work piece comprising:
a rotary saw with a blade,
a light beam source producing a beam of light,
a reflector,
said reflector mounted adjacent and co-axial to said blade,
said light beam source affixed to said rotary saw such that said beam of light is directed at said reflector and reflected to create a guideline.

2. The rotary saw and guide of claim 1 wherein said light beam source is a laser.

3. The rotary saw and guide of claim 1 further comprising a switch operatively connected to said light beam source for selectively activating said light beam source.

4. The rotary saw and guide of claim 3 in which said switch is operatively connected to said rotary saw such that activation of said rotary saw activates said light beam source.

5. The rotary saw and guide of claim 1 in which said reflector operates as a blade lock washer.

6. The rotary saw and guide of claim 1 in which said beam of light is partially intercepted by said reflector creating both said guideline and a direct point of light.

7. A method of providing a guide for use when operating a rotary saw comprising the steps of:
providing a rotary saw with a blade;
affixing adjacent to said blade and coaxially to said blade a reflector;
providing a light beam source;
projecting a beam of light co-planer to said reflector from said light beam source directed at said reflector; and
reflecting said beam of light off of said reflector to create a guideline.

8. The method of claim 7 wherein said light beam source is a laser.

9. A method of monitoring a rotary component comprising the steps of:
providing a rotary component;
affixing adjacent to said rotary component and coaxially to said rotary component a divergent reflector;
providing a light beam source;
projecting a beam of light -co-planer to said reflector from said light beam source directed at said reflector; and
monitoring said beam of light reflected off said reflector.

10. The method of claim 9 wherein said light beam source is a laser.
